(19) United States
(12) Patent Application Publication
(10) Pub. No.: US 2025/0246733 A1
(43) Pub. Date: Jul. 31, 2025

(54) STRUCTURAL ASSEMBLY FOR BATTERY STRUCTURE

(71) Applicant: Ford Global Technologies, LLC, Dearborn, MI (US)

(72) Inventor: Xiaogang Zhang, Novi, MI (US)

(73) Assignee: Ford Global Technologies, LLC, Dearborn, MI (US)

(21) Appl. No.: 18/428,558

(22) Filed: Jan. 31, 2024

(51) Int. Cl. H01M 50/209; H01M 50/222; H01M 50/227; H01M 50/233; H01M 50/249

(52) U.S. Cl. CPC H01M 50/209; H01M 50/222; H01M 50/227; H01M 50/233; H01M 50/249; H01M 2220/20

(57) ABSTRACT

A structural assembly includes a first structure, a second structure, and an insulation material. The first structure defines a first pocket that is configured to receive a first battery cell. The first structure includes a first side wall and at least one first rib located between the first battery cell and the first side wall to define a first gap between the first battery cell and the first side wall. The second structure defines a second pocket that is configured to receive a second battery cell. The second structure includes a second side wall and at least one second rib located between the second battery cell and the second side wall to define a second gap between the second battery cell and the second side wall. The insulation material is disposed between and contacts the first side wall and the second side wall.

### FIELD

The present disclosure relates to a structural assembly for a battery structure.

### BACKGROUND

The statements in this section merely provide background information related to the present disclosure and may not constitute prior art.

Vehicles such as battery-electric vehicles (BEVs), plug-in hybrid-electric vehicles (PHEVs), mild hybrid-electric vehicles (MHEVs), or full hybrid-electric vehicles (FHEVs) contain a traction battery, such as a high voltage (HV) battery, to act as a propulsion source for the vehicle. The HV battery may include components and systems to assist in managing vehicle performance and operations. The HV battery may include one or more arrays of battery cells interconnected electrically between battery cell terminals and interconnector busbars. The HV battery and surrounding environment may include a thermal management system to assist in managing temperature of the HV battery components, systems, and individual battery cells.

### SUMMARY

This section provides a general summary of the disclosure and is not a comprehensive disclosure of its full scope or all of its features.

In one form, the present disclosure provides a structural assembly for a battery structure. The structural assembly includes a first structure, a second structure, and an insulation material. The first structure defines a first pocket that is configured to receive a first battery cell. The first structure includes a first side wall and at least one first rib located between the first battery cell and the first side wall to define a first gap between the first battery cell and the first side wall. The second structure defines a second pocket that is configured to receive a second battery cell. The second structure includes a second side wall and at least one second rib located between the second battery cell and the second side wall to define a second gap between the second battery cell and the second side wall. The insulation material is disposed between and contacting the first side wall and the second side wall.

In variations of the structural assembly of the above paragraph, which can be implemented individually or in any combination: the structural assembly includes the first battery cell and the second battery cell; the insulation material is silica aerogel pad having a constant thickness; the thickness of the aerogel pad is greater than a thickness of the first side wall and the thickness of the aerogel pad is greater than a thickness of the second side wall; the thickness of the aerogel pad is greater than a thickness of the at least one first rib and the thickness of the aerogel pad is greater than a thickness of the at least one second rib; the at least one first rib includes a first rib member and a second rib member, the first rib member extending from a first upper end of the first side wall toward a first lower end of the first side wall and the second rib member extending from the first upper end of the first side wall toward the first lower end of the first side wall; the at least one second rib includes a third rib member and a fourth rib member, the third rib member extending from a second upper end of the second side wall toward a second lower end of the second side wall and the fourth rib member extending from the second upper end of the second side wall toward the second lower end of the second side wall; the first and second rib members cooperate to form an X-shape, and wherein the third and fourth rib members cooperate to form an X-shape; the first side wall and the second side wall are spaced apart from each other; each of the at least one first rib and the at least one second rib has a square or rectangular cross-section; the first side wall and the second side wall are made of plastic; and the at least one first rib extends from a first upper end of the first side wall toward a first lower end of the first side wall, the at least one second rib extends from a second upper end of the second side wall toward a second lower end of the second side wall.

In another form, the present disclosure provides a structural assembly for a battery structure. The structural assembly includes a first structure, a second structure, and an insulation material. The first structure defines a first pocket that is configured to receive a first battery cell. The first structure includes a first side wall and a plurality of first ribs. The first side wall has a first flat inside surface and a first flat outside surface. Each first rib of the plurality of first ribs extends from the first flat outside surface and is located between the first battery cell and the first side wall to define first gaps between the first battery cell and the first side wall. The second structure defines a second pocket that is configured to receive a second battery cell. The second structure includes a second side wall and a plurality of second ribs. The second side wall has a second flat inside surface and a second flat outside surface. Each second rib of the plurality of second ribs extends from the second flat outside surface and is located between the second battery cell and the second side wall to define second gaps between the second battery cell and the second side wall. The insulation material is sandwiched between the first side wall and the second side wall and has a constant thickness.

In variations of the structural assembly of the above paragraph, which can be implemented individually or in any combination: the insulation material is silica aerogel pad; the thickness of the aerogel pad is greater than a thickness of the first side wall and the thickness of the aerogel pad is greater than a thickness of the second side wall; the thickness of the aerogel pad is greater than a thickness of each of the first ribs and the thickness of the aerogel pad is greater than a thickness of each of the second ribs; at least one first rib of the plurality of first ribs extends from a first upper end of the first side wall toward a first lower end of the first side wall; at least one second rib of the plurality of second ribs extends from a second upper end of the second side wall toward a second lower end of the second side wall; two first ribs of the plurality of first ribs are perpendicular to each other, two second ribs of the plurality of second ribs are perpendicular to each other; the first side wall and the second side wall are spaced apart from each other; and at least one first rib of the plurality of first ribs extends diagonally along the first flat outside surface, at least one second rib of the plurality of second ribs extends diagonally along the second flat outside surface.

In yet another form, the present disclosure provides a structural assembly for a battery structure. The structural assembly includes a first battery cell, a second battery cell, a first structure, a second structure, and an insulation material. The first structure defines a first pocket that receives the first battery cell. The first structure includes a first side wall and a plurality of first ribs. The first side wall has a first flat inside surface and a first flat outside surface. Each first rib of the plurality of first ribs extends from the first flat outside surface and contacts the first battery cell such that first gaps are defined between the first battery cell and the first side wall. The second structure defines a second pocket that receives the second battery cell. The second structure includes a second side wall and a plurality of second ribs. The second side wall is spaced apart from the first side wall and has a second flat inside surface and a second flat outside surface. Each second rib of the plurality of second ribs extends from the second flat outside surface and contacts the second battery cell such that second gaps are defined between the second battery cell and the second side wall. The insulation material is sandwiched between the first side wall and the second side wall and has a constant thickness. The insulation material being made of a silica aerogel pad.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a vehicle including a battery housing assembly according to the principles of the present disclosure;

FIG. 2 is a schematic perspective view of the battery housing assembly of FIG. 1;

FIG. 3 is a perspective view of the battery housing assembly of FIG. 1 with a lid of the battery housing assembly removed for clarity of illustration;

FIG. 4 is a perspective view of one structural assembly of the battery housing assembly of FIG. 1;

FIG. 5 is a partially exploded view of one structural assembly of the battery housing assembly of FIG. 1; and

FIG. 6 is an end view of one structural assembly of the battery housing assembly of FIG. 1.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

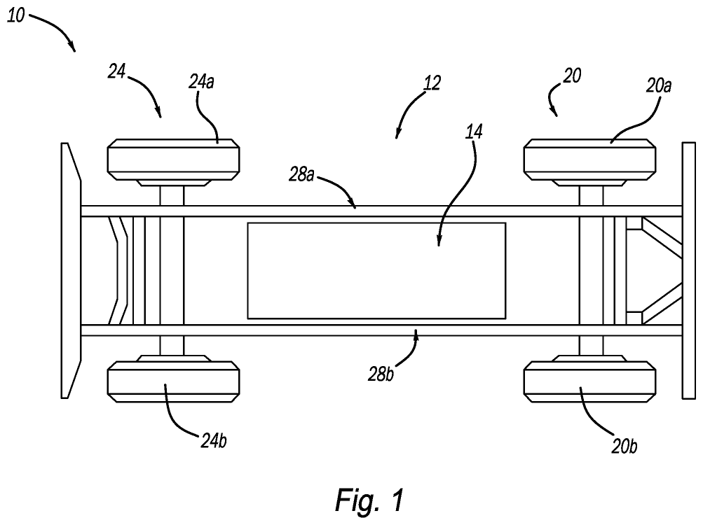

With reference to FIG. 1, a vehicle 10 such as an electric vehicle is shown. In the example provided, the electric vehicle is a battery electric vehicle (BEV). In other examples, the electric vehicle may be a hybrid electric vehicle (HEV), a plug-in electric vehicle (PHEV), or a fuel cell vehicle, among others. The vehicle 10 includes a vehicle frame 12 and a battery structure or battery housing assembly 14. The vehicle frame 12 is the main supporting structure of the vehicle 10, to which various components are attached either directly or indirectly. The vehicle frame 12 includes opposed longitudinal rails 28a, 28b. The rails 28a, 28b are spaced apart from each other and may establish a length of the vehicle frame 12. In the example illustrated, the vehicle 10 is a body on frame vehicle architecture, though other configurations can be used, such as a unibody architecture, for example.

The battery housing assembly 14 powers a rear motor (not shown) to drive rear wheels 20a, 20b of a set of rear wheels 20 via a rear axle and/or powers a front motor (not shown) to drive front wheels 24a, 24b of a set of front wheels 24 via a front axle.

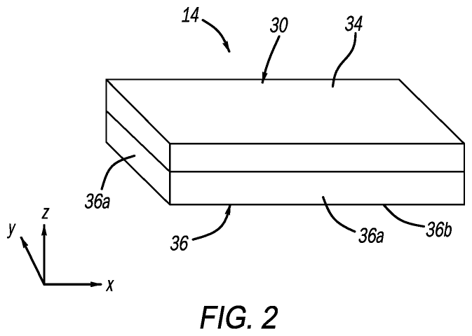

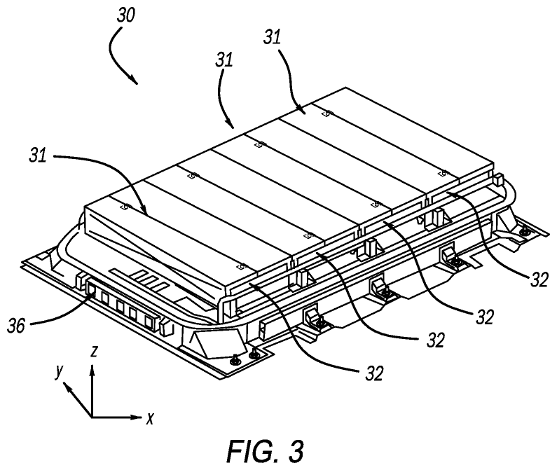

With reference to FIGS. 2 and 3, the battery housing assembly 14 includes a battery tray or housing 30, a plurality of structural assemblies 31 (FIG. 3), and one or more batteries or battery cells 32 (FIG. 3). The battery housing 30 is an enclosure which provides a structural surrounding and sealed compartment for the structural assemblies 31, battery cells 32 and other battery components such as cooling lines, support brackets, and wiring disposed therein or extending therethrough. The battery housing 30 may be disposed at various locations of the vehicle 10 and is mounted to the vehicle frame 12. In this way, the battery housing 30 is supported by the vehicle frame 12 and is remote from a passenger cabin (not shown) and cargo compartments (not shown) of the vehicle 10, therefore, not occupying space that would otherwise be available for passengers or cargo. The battery housing 30 includes a cover or lid 34, a body 36, and a seal (not shown). The lid 34 may optionally be removably coupled to the body 36 via mechanical fasteners such as bolts or screws (not shown), for example. In this way, the lid 34 may be removed to service the structural assemblies 31 and/or battery cells 32 disposed within the battery housing 30, for example.

The body 36 includes a plurality of side walls or panels 36a and a bottom wall or panel 36b. The side walls 36a may be manufactured via stamping, for example, and extend in a vertical direction Z. The side walls 36a define an outer boundary of the battery housing 30 and are secured to each other via welding or an adhesive, for example. The bottom wall 36b supports the battery cells 32 disposed within the battery housing 30 and is secured to lower portions of the side walls 36a. The seal is disposed around a periphery of the body 36 and is engaged with the body 36 and the lid 34. In this way, fluids, debris and other materials are inhibited from entering into the battery housing 30.

The structural assemblies 31 are spaced apart from each other and are aligned along a longitudinal direction X of the battery housing assembly 14. Each structural assembly 31 is disposed between adjacent battery cells 32 and inhibit heat from being transferred between the adjacent battery cells 32. In the example illustrated, the battery cells 32 are prismatic battery cells that extend from one side wall 36a of the body 36 to another opposing side wall 36a of the body 36. Each structural assembly 31 includes a first structure 40, a second structure 42, and an insulation material 44.

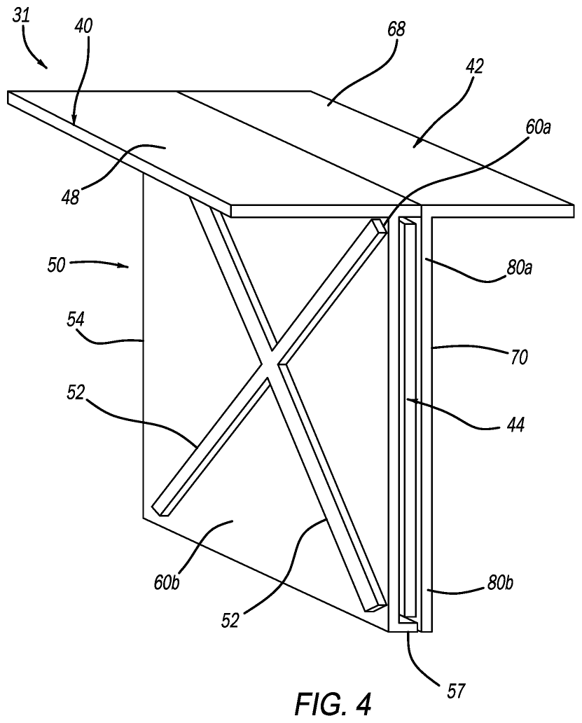

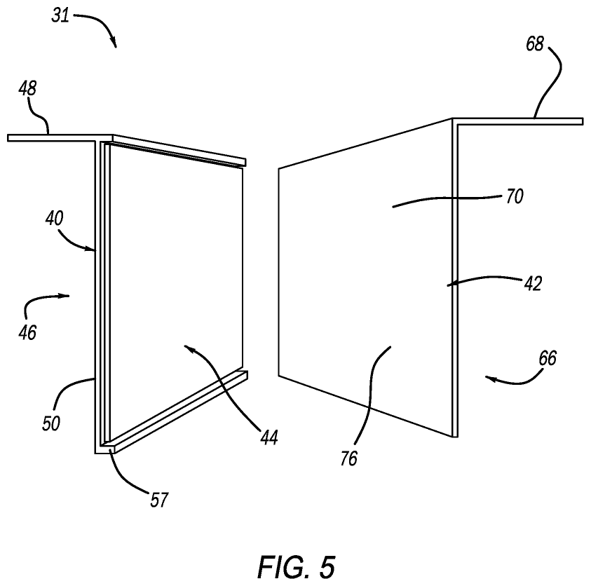

With reference to FIGS. 4-6, the first structure 40 is made of an insulative material (e.g., plastic) and defines a pocket 46 that receives one battery cell 32. The first structure 40 has a generally L-shape and is made of a unitized structure including an upper portion 48, a side wall 50, and one or more ribs 52. The upper portion 48 extends perpendicular from an upper end of the side wall 50 to cover the insulation material 44. The upper portion 48 also extends over a top portion of the battery cell 32 received in the pocket 46 thereby covering the battery cell 32. In the example illustrated, the upper portion 48 contacts the battery cell 32. In some forms, the upper portion 48 is spaced apart from the battery cell 32.

The side wall 50 is oriented in a vertical direction and is spaced apart from the battery cell 32 received in the pocket 46. The side wall 50 may have a solid structure that does not includes gaps, openings or apertures formed therein. The side wall 50 may be secured to the bottom wall 36b of the body 36 by an adhesive, mechanical fasteners, or any other suitable attachment means. In the example illustrated, the side wall 50 includes an outside 54 having a flat outside surface, and an inside 56 having a flat inside surface. The outside 54 defines the pocket 46 and the outside surface is spaced apart from the battery cell 32 disposed within the pocket 46. The inside surface contacts the insulation material 44. An optional flange 57 may extend from the side wall 50 underneath the insulation material 44, thereby covering a lower portion of the insulation material 44.

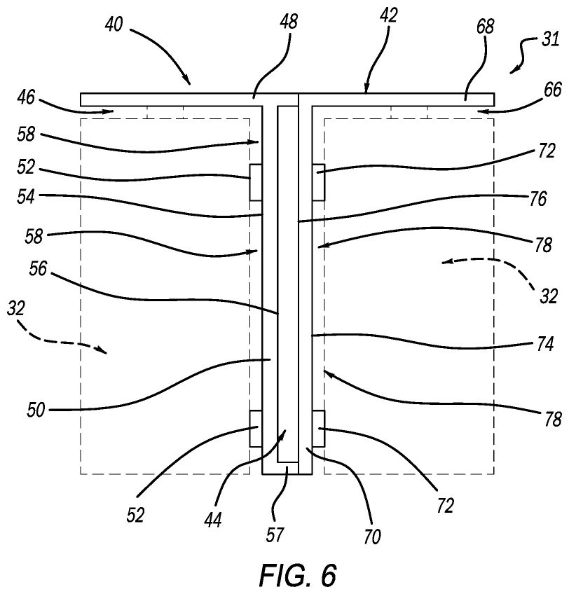

The ribs 52 extend from the outside surface of the side wall 50 and contacts the battery cell 32 received in the pocket 46, thereby forming an air gap 58 (FIG. 6) between the battery cell 32 and the side wall 50. The air gap 58 provides insulation for heat generated by the battery cell 32 such that the heat is not transferred through the structural assembly 31 to an adjacent battery 32. Each rib 52 has a square or rectangular cross-section and has a thickness that is equal to a thickness of the side wall 50. For example, the thickness of each rib 52 and the thickness of the side wall 50 may be 0.75 millimeters (mm). In some forms, the thickness of each rib 52 may be different from the thickness of the side wall 50. In the example illustrated, the first structure 40 has two ribs 52 extending from an upper end 60a of the side wall 50 to a lower end 60b of the side wall 50. That is, one rib 52 extends diagonally from a left corner located at the upper end 60a to a right corner located at the lower end 60b, and another rib 52 extends diagonally from a right corner located at the upper end 60a to a left corner located at the lower end 60b. Stated differently, the two ribs 52 are perpendicular to each other so as to form a X-shape.

In some forms, the first structure 40 may include only one rib 52 or more than two ribs. In one example, the ribs 52 may be located vertically along the outside surface of the side wall 50 in equal intervals. In another example, the ribs 52 may be located horizontally along the outside surface of the side wall 50 in equal intervals. In yet another example, the ribs 52 may be located vertically, horizontally, and/or diagonally along the outside surface of the side wall 50. The ribs 52 may extend along the outside surface of the side wall 50 in a desired pattern such that a uniform compression is applied to the battery cell 32. The ribs 52 also enhance the structural integrity of the first structure 40.

The second structure 44 is made of an insulative material (e.g., plastic) and defines a pocket 66 that receives one battery cell 32. The second structure 44 has a generally L-shape and is made of a unitized structure including an upper portion 68, a side wall 70, and one or more ribs 72. The upper portion 68 extends perpendicular from an upper end of the side wall 70 away from the insulation material 44. In the example illustrated, the upper portion 68 extends over a top portion of the battery cell 32 received in the pocket 66 and covers the battery cell 32. In the example illustrated, the upper portion 68 contacts the battery cell 32 and contacts the upper portion 48 of the first structure 40. In some forms, the upper portion 68 is spaced apart from the battery cell 32 and/or the insulation material 44 may extend between the upper portions 48, 68 of the first and second structures 40, 44, respectively.

The side wall 70 is oriented in a vertical direction and is spaced apart from the battery cell 32 received in the pocket 66 and the side wall 50 of the first structure 40. The side wall 70 may have a solid structure that does not includes gaps, openings or apertures formed therein. The side wall 70 may be secured to the bottom wall 36b of the body 36 by an adhesive, mechanical fasteners, or any other suitable attachment means. In the example illustrated, the side wall 70 includes an outside 74 having a flat outside surface, and an inside side 76 having a flat inside surface. The outside 74 defines the pocket 66 and the outside surface is spaced apart from the battery cell 32 disposed within the pocket 66. The inside surface contacts the insulation material 44.

The ribs 72 extend from the outside surface of the side wall 70 and contacts the battery cell 32 received in the pocket 66, thereby forming an air gap 78 (FIG. 6) between the battery cell 32 and the side wall 70. The air gap 78 provides insulation for heat generated by the battery cell 32 such that the heat is not transferred through the structural assembly 31 to an adjacent battery 32. Each rib 72 has a square or rectangular cross-section and has a thickness that is equal to a thickness of the side wall 70. For example, the thickness of each rib 72 and the thickness of the side wall 70 may be 0.75 millimeters (mm). In the example illustrated, the first structure 60 has two ribs 72 extending from an upper end 80a of the side wall 70 to a lower end 80b of the side wall 70. That is, one rib 72 extends diagonally from a left corner located at the upper end 80a to a right corner located at the lower end 80b, and another rib 72 extends diagonally from a right corner located at the upper end 80a to a left corner located at the lower end 80b. Stated differently, the two ribs 72 are perpendicular to each other so as to form a X-shape.

In some forms, the second structure 44 may include only one rib 72 or more than two ribs 72. In one example, the ribs 72 may be located vertically along the outside surface of the side wall 70 in equal intervals. In another example, the ribs 72 may be located horizontally along the outside surface of the side wall 70 in equal intervals. In yet another example, the ribs 72 may be located vertically, horizontally, and/or diagonally along the outside surface of the side wall 70. The ribs 72 may extend along the outside surface of the side wall 70 in a desired pattern such that a uniform compression is applied to the battery cell 32. The ribs 72 also enhance the structural integrity of the first structure 40.

The insulation material 44 is disposed between and contacting the side wall 50 and the side wall 70. In the example illustrated, the insulation material 44 is made of a material that is heat resistant, for example, such as a fiber pad carrying powder having high heat insulation such as a silica aerogel. In the example illustrated, the insulation material 44 is sandwich between the side wall 50 and the side wall 70 and has a constant thickness to inhibit hot spots in the insulation material 44. The insulation material 44 is oriented vertically and has a height that is substantially equal to a height of the side walls 50, 70. The thickness of the insulation material 44 is greater than a thickness of the side wall 50 and the thickness of the insulation material 44 is greater than a thickness of the side wall 70. For example, the insulation material 44 may have a thickness of one millimeter (mm) while the side walls 50, 70 have a thickness of the 0.75 millimeters (mm). The thickness of the insulation material 44 is also greater than a thickness of the ribs 52 and the thickness of the insulation material 44 is greater than a thickness of the ribs 72. For example, the insulation material 44 may have a thickness of one millimeter (mm) while the ribs 52, 72 have a thickness of the 0.75 millimeters (mm).

The structural assemblies 31 of the present disclosure provides air gaps 58, 78 that have similar thermal conductivity as the insulation material 44. In this way, multiple thermal insulation barriers (the air gaps 58, 78, the side walls 50, 70, and the insulation material 44) are formed between adjacent batteries 32 to inhibit heat generated by one battery 32 from being transferred to another adjacent battery 32. This also allows the thickness of the insulation material to be reduced in the structural assemblies 31.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A structural assembly for a battery structure, the structural assembly comprising:
a first structure defining a first pocket that is configured to receive a first battery cell, the first structure including a first side wall and at least one first rib located between the first battery cell and the first side wall to define a first gap between the first battery cell and the first side wall;
a second structure defining a second pocket that is configured to receive a second battery cell, the second structure including a second side wall and at least one second rib located between the second battery cell and the second side wall to define a second gap between the second battery cell and the second side wall; and
insulation material disposed between and contacting the first side wall and the second side wall.

2. The structural assembly of claim 1, wherein further comprising the first battery cell and the second battery cell.

3. The structural assembly of claim 1, wherein the insulation material is silica aerogel pad having a constant thickness.

4. The structural assembly of claim 3, wherein the thickness of the aerogel pad is greater than a thickness of the first side wall and the thickness of the aerogel pad is greater than a thickness of the second side wall.

5. The structural assembly of claim 3, wherein the thickness of the aerogel pad is greater than a thickness of the at least one first rib and the thickness of the aerogel pad is greater than a thickness of the at least one second rib.

6. The structural assembly of claim 1, wherein:
the at least one first rib includes a first rib member and a second rib member, the first rib member extending from a first upper end of the first side wall toward a first lower end of the first side wall and the second rib member extending from the first upper end of the first side wall toward the first lower end of the first side wall; and
the at least one second rib includes a third rib member and a fourth rib member, the third rib member extending from a second upper end of the second side wall toward a second lower end of the second side wall and the fourth rib member extending from the second upper end of the second side wall toward the second lower end of the second side wall.

7. The structural assembly of claim 6, wherein the first and second rib members cooperate to form an X-shape, and wherein the third and fourth rib members cooperate to form an X-shape.

8. The structural assembly of claim 1, wherein the first side wall and the second side wall are spaced apart from each other.

9. The structural assembly of claim 1, wherein each of the at least one first rib and the at least one second rib has a square or rectangular cross-section.

10. The structural assembly of claim 1, wherein the first side wall and the second side wall are made of plastic.

11. The structural assembly of claim 1, wherein the at least one first rib extends from a first upper end of the first side wall toward a first lower end of the first side wall, and wherein the at least one second rib extends from a second upper end of the second side wall toward a second lower end of the second side wall.

12. A structural assembly for a battery structure, the structural assembly comprising:
a first structure defining a first pocket that is configured to receive a first battery cell, the first structure including a first side wall and a plurality of first ribs, the first side wall having a first flat inside surface and a first flat outside surface, each first rib of the plurality of first ribs extends from the first flat outside surface and is located between the first battery cell and the first side wall to define first gaps between the first battery cell and the first side wall;
a second structure defining a second pocket that is configured to receive a second battery cell, the second structure including a second side wall and a plurality of second ribs, the second side wall having a second flat inside surface and a second flat outside surface, each second rib of the plurality of second ribs extends from the second flat outside surface and is located between the second battery cell and the second side wall to define second gaps between the second battery cell and the second side wall; and
insulation material sandwiched between the first side wall and the second side wall and having a constant thickness.

13. The structural assembly of claim 12, wherein the insulation material is silica aerogel pad.

14. The structural assembly of claim 13, wherein the thickness of the aerogel pad is greater than a thickness of the first side wall and the thickness of the aerogel pad is greater than a thickness of the second side wall.

15. The structural assembly of claim 13, wherein the thickness of the aerogel pad is greater than a thickness of each of the first ribs and the thickness of the aerogel pad is greater than a thickness of each of the second ribs.

16. The structural assembly of claim 12, wherein:
at least one first rib of the plurality of first ribs extends from a first upper end of the first side wall toward a first lower end of the first side wall; and
at least one second rib of the plurality of second ribs extends from a second upper end of the second side wall toward a second lower end of the second side wall.

17. The structural assembly of claim 12, wherein two first ribs of the plurality of first ribs are perpendicular to each other, and wherein two second ribs of the plurality of second ribs are perpendicular to each other.

18. The structural assembly of claim 12, wherein the first side wall and the second side wall are spaced apart from each other.

19. The structural assembly of claim 12, wherein at least one first rib of the plurality of first ribs extends diagonally along the first flat outside surface, and wherein at least one second rib of the plurality of second ribs extends diagonally along the second flat outside surface.

20. A battery structure comprising:
a first battery cell and a second battery cell;
a first structure defining a first pocket that receives the first battery cell, the first structure including a first side wall and a plurality of first ribs, the first side wall having a first flat inside surface and a first flat outside surface, each first rib of the plurality of first ribs extends from the first flat outside surface and contacts the first battery cell such that first gaps are defined between the first battery cell and the first side wall;
a second structure defining a second pocket that receives the second battery cell, the second structure including a second side wall and a plurality of second ribs, the second side wall spaced apart from the first side wall and having a second flat inside surface and a second flat outside surface, each second rib of the plurality of second ribs extends from the second flat outside surface and contacts the second battery cell such that second gaps are defined between the second battery cell and the second side wall; and
insulation material sandwiched between the first side wall and the second side wall and having a constant thickness, the insulation material being made of a silica aerogel pad.
